(19) United States
(12) Patent Application Publication
(10) Pub. No.: US 2026/0008715 A1
(43) Pub. Date: Jan. 8, 2026

(54) OPTICAL GLASS WITH HIGH REFRACTIVE INDEX

(71) Applicants: Morita EIMITSU, Hubei (CN); Yamashita YUTAKA, Hubei (CN); Ke ZHANG, Hubei (CN); Liang LI, Hubei (CN); Bo WANG, Hubei (CN); Rong LIU, Hubei (CN)

(72) Inventors: Morita EIMITSU, Hubei (CN); Yamashita YUTAKA, Hubei (CN); Ke ZHANG, Hubei (CN); Liang LI, Hubei (CN); Bo WANG, Hubei (CN); Rong LIU, Hubei (CN)

(21) Appl. No.: 19/012,867

(22) Filed: Jan. 8, 2025

(30) Foreign Application Priority Data
Jul. 5, 2024 (CN) 2024109002523

(51) Int. Cl. C03C 3/068

(52) U.S. Cl. CPC C03C 3/068; C03C 2201/28; C03C 2201/3411; C03C 2201/3417; C03C 2201/3452; C03C 2201/3488; C03C 2201/42; C03C 2201/58

(57) ABSTRACT

An optical glass having the following oxides in mass percentage relative to a total mass of the optical glass: 10.0%-30.0% SiO₂, 10.0%-30.0% P₂O₅, 0.1%-5.0% B₂O₃, 0.1%-10.0% Al₂O₃, 0.1%-10.0% Rn oxides, 1.0%-20.0% R oxides, 0.1%-5.0% ZrO₂, 10.0%-30.0% TiO₂, 15.0%-50.0% Nb₂O₅, 0.1%-10.0% Ln oxides, and 0.1%-10.0% WO₃, wherein TiO₂+Nb₂O₅+P₂O₅+the R oxides accounts for 60.01% or above.

### BACKGROUND OF THE INVENTION

The present invention relates to the technical field of glass products, and in particular, to an optical glass with a high refractive index.

In recent years, wearable devices in various forms have been developed and marketed, such as head mounted devices and smart glasses. Head mounted devices typically cover the user's field of view and are used as systems for experiencing virtual reality (VR), while smart glasses are often used as systems for experiencing augmented reality (AR) without blocking the user's field of view.

Propagation of an electromagnetic wave in one medium is different from that in another medium. In theory, an electromagnetic wave of a certain wavelength propagates at the speed of light in vacuum, but propagates at a different speed (less than the speed of light) in different media. A ratio of the propagation speed (the speed of light) of the electromagnetic wave in vacuum to its propagation speed (referred to as the phase speed) in a medium is referred to as the refractive index of that medium. The concept of refractive index assumes that a medium is transparent or substantially transparent to the electromagnetic wave, in other words, the electromagnetic wave can propagate in the medium. Only the electromagnetic waves with wavelengths in the visible region of the electromagnetic spectrum are considered, and the visible electromagnetic waves are hereinafter collectively referred to as “visible light”.

Glass material is a medium that may have a refractive index different from that of an environmental medium (such as air). Through the use of glass material, the difference in refractive index can be used to manipulate the visible light. For example, by converging or dispersing visible light from one medium to another medium (e.g., from air through a lens to air again), the difference in refractive index can be used to make the glass material into a lens. In another example, the glass material can be used to direct visible light from one place to another place using the concepts of difference in refractive index and internal reflection.

Given that other conditions are the same, the larger the refractive index of the glass material for making the lens is, the shorter the focal length of the lens and thus the higher the refractive index will be. This is an important attribute of a lens designed to manipulate visible light for detection, such as a lens in a digital camera. In addition, the higher the refractive index of the lens is, the larger the aperture of the lens will be, and so, the smaller will be the minimum length of an object that the lens can identify (i.e. the higher the refractive index of the lens is, the “higher” the resolution of the lens). This is an important attribute of a lens of a microscope, and ideally, the lens of a microscope should be able to identify an object as small as possible. In addition, the angle of view of a camera is a function of the focal length of the lens used in the camera. Specifically, the shorter the focal length of the lens is, the wider will be the angle of view of the camera using such a lens. As described above, the larger the refractive index of the lens is, the shorter the focal length of the lens will be. Therefore, the larger the refractive index of the lens is, the wider the angle of view of the camera will be.

In addition to the functions of the lens described above, visible light can be directed from one place to another place according to the difference in refractive index of a medium relative to its surrounding medium. When visible light propagates in a first medium (e.g., a glass material) having a first refractive index in accordance with a certain angle of incidence with respect to a normal line, and then reaches a boundary line between the first medium and a second medium (e.g., air) with a second low refractive index, a portion of the visible light will then leave the first medium and propagate in the second medium, while another portion of the visible light will then be reflected back to the first medium. If the angle of incidence increases such that the incident light ray propagates at a narrower angle with respect to the boundary line between the first medium and the second medium, an amount of the visible light reflected back to the first medium (glass material) will increase, while an amount of the visible light transmitting through the boundary and propagating in the second medium (air) will decrease. At a certain angle of incidence (i.e. the “critical angle”), all the visible light is reflected back to the first medium (glass material), which is generally referred to as “total internal reflection”. The critical angle and the amounts of light reflected at different angles of incidence between the angle coinciding the normal line and the critical angle are functions of the difference in refractive index between the two media. Therefore, given that other conditions are the same, the higher the refractive index of the glass material is, the greater the amount of internal reflection of the glass material will be, and the larger the critical angle will become, meaning that the incident light ray will intersect with the boundary line between the glass material and its surrounding media (i.e. air) at the narrower angle with respect to said boundary line. This is an important attribute of glass material as a visible light guide in wearable augmented reality or virtual reality devices.

In certain applications such as augmented/virtual reality devices or digital cameras where glass material is used, it may be beneficial to make these devices or cameras as lightweight as possible for use to prevent user's fatigue. Therefore, the glass material should also be as lightweight as possible, in other words, the glass material has to be as low-density as possible. However, the chemical components added to increase the refractive index of the glass material may also increase the density of the glass material, thereby increasing the weight of the lens which these devices or cameras use.

In addition, as described above, the glass material needs to be as transparent as possible to visible light. In other words, the glass material needs to absorb as little visible light as possible. However, the chemical components added to increase the refractive index of the glass material may reduce the light transmittance of the lens.

### BRIEF SUMMARY OF THE INVENTION

An objective of the present invention is to provide an optical glass with a high refractive index to solve the problems mentioned in the background. In order to achieve the above objective, the present invention provides the following technical solutions:

An optical glass, comprising the following oxides in mass percentage relative to a total mass of the optical glass:

10.0%-30.0% SiO₂, 10.0%-30.0% P₂O₅, 0.1%-5.0% B₂O₃, 0.1%-10.0% Al₂O₃, 0.1%-10.0% Rn oxides, 1.0%-20.0% R oxides, 0.1%-5.0% ZrO₂, 10.0%-30.0% TiO₂, 15.0%-50.0% Nb₂O₅, 0.1%-10.0% Ln oxides, and 0.1%-10.0% WO₃, wherein TiO₂+Nb₂O₅+P₂O₅+the R oxides accounts for 60.01% or above.

Further, the R oxides comprise 3MgCO₃, 4MgCO₃, CaCO₃, SrO₂, BaCO₃, and Ba(NO₃)₂.

Further, the Ln oxides comprise Y₂O₃, Gd₂O₃, and Yb₂O₃.

Further, the optical glass has a refractive index (nd) between 1.80000 and 2.40000, a λ80 of less than 430 nm, and an Abbe number (vd) between 15.0 and 25.0.

Further, the optical glass has a weight per volume of between 2.90 g/cm³ and 3.00 g/cm³.

The present invention has the following beneficial effects: The optical glass according to the present invention can achieve the technical effects of increasing the surface compressive stress of the compressive stress layers while reducing the central compressive stress, and having strong impact resistance, meaning that even if the glasses are impacted and thus damaged, they are not easy to be broken into shattered fragments.

### DETAILED DESCRIPTION OF THE INVENTION

The composition and preparation method of the present invention are further described in detail below with reference to specific examples, but the present invention is not limited to the following embodiments and examples, and can be carried out with appropriate modifications within the scope of the objective of the present invention.

The present invention provides an optical glass with a high refractive index, which comprises the following oxides in mass percentage relative to a total mass of the optical glass:

10.0%-30.0% SiO₂, 10.0%-30.0% P₂O₅, 0.1%-5.0% B₂O₃, 0.1%-10.0% Al₂O₃, 0.1%-10.0% Rn oxides, 1.0%-20.0% R oxides, 0.1%-5.0% ZrO₂, 10.0%-30.0% TiO₂, 15.0%-50.0% Nb₂O₅, 0.1%-10.0% Ln oxides, and 0.1%-10.0% WO₃, wherein TiO₂+Nb₂O₅+P₂O₅+the R oxides accounts for 60.01% or above.

When each of SiO₂ and P₂O₅ has a mass percentage of 10.0% or above, transmittance to short-wavelength visible light can be increased by reducing the coloration of the glass, and stable glass formation is facilitated to increase devitrification resistance of the glass. By controlling the mass percentage of SiO₂ to 30.0% or less, a decrease in refractive index due to presence of the SiO₂ can be suppressed, and thus a high refractive index can be obtained more easily. Therefore, in the present invention, among the equivalents of oxides making the optical glass, SiO₂ has a mass percentage of preferably 30.0% or less, more preferably 29.5% or less, and most preferably 29.0% or less, relative to the total mass of the optical glass; in another aspect, among the equivalents of oxides making the optical glass, SiO₂ has a mass percentage of preferably 10.0% or more, more preferably 15.0% or more, and most preferably 18.0% or more, relative to the total mass of the optical glass.

B₂O₃ is a component of the optical glass in the present invention, which facilitates stable glass formation to increase devitrification resistance. By controlling a mass percentage of B₂O₃ to 5.0% or less, a decrease in refractive index due to the presence of B₂O₃ can be suppressed, and thus a high refractive index can be obtained more easily. In the present invention, among the equivalents of oxides making the optical glass, B₂O₅ has a mass percentage of preferably 5.0% or less, more preferably 4.8% or less, and most preferably 4.6% or less, relative to the total mass of the optical glass. In another aspect, among the equivalents of oxides making the optical glass, B₂O₃ has a mass percentage of preferably 1.2% or more, more preferably 2.2% or more, and most preferably 3.3% or more, relative to the total mass of the optical glass.

Al₂O₃ is also a component of the optical glass in the present invention. When its mass percentage is 0.1% or more, the viscosity of the optical glass during melting can be increased and the chemical durability of the optical glass can be improved. In the present invention, when the mass percentage of Al₂O₃ is 10.0% or less, the melting property of the optical glass is improved and the devitrification tendency of the glass is reduced. In another aspect, among the equivalents of oxides making the optical glass, Al₂O₃ has a mass percentage of preferably 10.0% or less, more preferably 5.0% or less, and most preferably 3.0% or less, relative to the total mass of the optical glass.

When a total mass percentage of the Rn oxides is 10.0% or less, more preferably 9.0% or less, and most preferably 8.0% or less, a desired coloration in the present invention is obtained. In another aspect, a lowest possible total mass percentage of the Rn oxides is preferably 0.1% or more, more preferably 1.0% or more, and most preferably 2.0% or more.

When a total mass percentage of the R oxides is 1.0% or above, the stability of the glass can be improved. In particular, the R oxides function to inhibit the permeation of TiO₂. In the present invention, the total mass percentage of the R oxides is preferably 8.0% or more, more preferably 10.0% or more, or 12.0% or more, and most preferably 15.0% or more. In another aspect, to prevent or least reduce a decrease in refractive index, the total mass percentage of the R oxides is preferably 20.0% or less, more preferably 19.5% or less, further preferably 19.0% or less, furthermore preferably 18.5% or less, and most preferably 18.0% or less.

ZrO₂ is a component of the optical glass in the present invention. When a mass percentage of the ZrO₂ is 0.1% or above, the coloration of the glass can be reduced, the transmittance to short-wave visible light can be increased, stable glass formation can be promoted, and the light transmittance of the glass can be increased. In another aspect, by controlling the mass percentage of the ZrO₂ to 5.0% or less, devitrification due to excessive ZrO₂ can be reduced. Therefore, among the equivalents of oxides making the optical glass, ZrO₂ has a mass percentage of preferably 5.0% or less, more preferably 4.5% or less, and most preferably 4.0% or less, relative to the total mass of the optical glass. In another aspect, among the equivalents of oxides making the optical glass, ZrO₂ has a mass percentage of preferably 1.0% or more, more preferably 2.0% or more, and most preferably 3.0% or more, relative to the total mass of the optical glass.

By controlling a mass percentage of the Ln oxides to 10.0% or less, devitrification due to excessive Ln oxides can be suppressed, and a gram to cm³ (g/cm³) of the optical glass can kept low. Therefore, a greatest possible mass percentage of the Ln oxides is preferably 10.0% or less, more preferably 8.0% or less, further preferably 6.0% or less, furthermore preferably 4.0% or less, and most preferably 1.0% or less.

A total amount of the TiO₂, Nb₂O₅, P₂O₅, and the R oxides can be reduced to 90.0% or less to reduce the gram to cm³ (g/cm³) of the optical glass. Many components contributing to the high refractive index account for more amounts in the optical glass compared with other components. By suppressing the amounts of these components contributing to the high refractive index, the gram to cm³ (g/cm³) of the optical glass can be kept low so that an optical apparatus can be made as small and as light as possible. Therefore, the total mass of TiO₂. Nb₂O₅, P₂O₅, and the R oxides is preferably 88.0% or less, more preferably 86.0% or less, and most preferably 84.0% or less. In another aspect, in terms of improving refractive index and dispersion, the total mass of TiO₂. Nb₂O₅, P₂O₅, and the R oxides may be 60.01% or more.

WO₃ is a component of the optical glass in the present invention. When the mass percentage of WO₃ is 0.1% or more, the effect of improving the strength and elastic modulus of the optical glass is obtained. In particular, the mass percentage of WO₃ can be reduced to 10.0% or less to improve the melting property of the optical glass and reduce the devitrification tendency of the optical glass. Therefore, among the equivalents of oxides making the optical glass, the mass percentage of WO₃ is preferably 10.0% or less, more preferably 5.0% or less, and most preferably 3.0% or less, relative to the total mass of the optical glass.

Specifically, the Rn oxides comprise Li₂CO₃, LiNO₃, Na₂CO₃, NaNO₃, K₂CO₃, KNO₃, RbO₂, and Cs₂O. In order to obtain the desired high refractive index according to the present invention, Li₂CO₃, K₂CO₃, and Na₂CO₃ of the Rn oxides can be involved in ion exchanges in a chemical strengthening process, in which Li₂CO₃, K₂CO₃, and Na₂CO₃ are the object exchange substances of (K+) and (Li+) during ion exchanges; Li₂CO₃, K₂CO₃, and Na₂CO₃ have an effect of reducing dissolution viscosity and prevent dissolution and devitrification (i.e. they are devitrification resistant components). However, too many of these components may results in deterioration in chemical durability and permeation resistance.

Specifically, the R oxides comprise 3MgCO₃, 4MgCO₃, CaCO₃, SrO₂, BaCO₃, and Ba(NO₃)₂.

Specifically, the Ln oxides comprise Y₂O₃, Gd₂O₃, and Yb₂O₃.

Specifically, the optical glass has a refractive index (nd) between 1.80000 and 2.40000, a λ80 of less than 430 nm, and an Abbe number (vd) between 15.0 and 25.0.

Specifically, the optical glass has a gram to cm³ (g/cm³) of between 2.90 and 3.00.

A method for preparing the optical glass of the present invention, comprising the steps of: mixing raw materials evenly according to the above mentioned mass percentages of the oxides to obtain a mixture; in one embodiment, the mixing is carried out in a mixer for a period of 5-60 min, and the mixer rotates at a speed of 1.0-30 rpm; melting the mixture in a quartz crucible, a zircon crucible, or a platinum crucible to form a melted mixture at a melting temperature of 1500-1700° C. for a period of 2-72 h; and the melting temperature is reduced to 1000-1450° C. at a start of a subsequent cooling step of the melted mixture, and then the melted mixture is poured into a mold in which the cooling step is performed where the melted mixture is slowly cooled to produce a glass sheet.

The optical glass of the present invention can be melted and shaped by known methods. The particular method of forming the melted mixture shall not be limited to the method described herein.

The optical glass eventually produced can be further processed to form a molded glass body, for example, by grinding and/or molding such as a secondary heat press molding or precise press molding. In other words, the molded glass body may be produced by grinding and polishing and/or other processing methods of the optical glass. The processing methods for producing the molded glass body are not limited to the processing methods described herein.

The glass sheet can be further subject to a chemical strengthening process to form compressive stress layers, particularly comprising the following steps: The glass sheet is in contact with or soaked in a molten salt containing potassium or sodium, such as potassium nitrate (KNO₃), sodium nitrate (NaNO₃), a mixture thereof or a compound salt thereof, carried out in one, two, or three stages;

for example, in case of a two-stage treatment, in the first stage, the glass sheet is in contact with or soaked in a sodium salt or a mixed salt of potassium and sodium for 1-720 min, preferably 30-500 min; then in the second stage, the glass sheet already subject to the first stage processing is in contact with or soaked in a potassium salt or a mixed salt of potassium and sodium for 1-720 min, preferably 10-500 min; in case of one-stage treatment, the glass sheet is in contact with or soaked in a potassium salt, a sodium salt, or a mixed salt thereof for 1-1440 min, preferably 60-800 min;

next, heating the glass sheet already subject to the previous treatment to 300-600° C. and then rapid cooling it, such as by water-cooling and/or air-cooling, so that compressive stress layers can be formed through a temperature difference between a surface and an interior of the rapidly cooled glass sheet.

Alternatively, the glass sheet can be further subject to ion implantation process to form compressive stress layers, particularly comprising the following steps: ions are implanted into the surface of the glass sheet under accelerated energy and accelerated voltage through collision of any ions with the surface of the glass sheet without damaging the surface of the glass sheet; subsequently, heating and rapid cooling treatments as same as those described in the previous paragraph are carried out as needed to form the compressive stress layers on the surface of the glass sheet.

As shown in Table 1 below, the compositions of optical glasses according to some examples of the present invention, the composition of an optical glass according to a comparative example, and values of the refractive index (nd), Abbe number (vd), and g/cm³ of these optical glasses are shown and compared.

TABLE 1

| Example | | 1 | 2 | 3 | 4 | 5 | 6 | 7 |
|---|---|---|---|---|---|---|---|---|
| Oxide | SiO₂ | 30.00 | 16.62 | 13.40 | 20.00 | 11.44 | 11.65 | 11.74 |
| (mass | P₂O₅ | 17.00 | 10.35 | 13.34 | 10.11 | 15.33 | 20.00 | 10.00 |
| percentage | B₂O₃ | 0.55 | 5.00 | 2.21 | 0.50 | 2.00 | 1.33 | 1.00 |
| %) | Al₂O₃ | 0.55 | 1.22 | 3.58 | 2.07 | 1.00 | 2.22 | 1.00 |
| | Li₂CO₃ | 0.50 | 1.00 | 1.80 | 0.88 | 0.20 | 0.64 | 0.20 |
| | LiNO₃ | 0.24 | 0.25 | 0.12 | 0.55 | 0.10 | 0.11 | 0.10 |
| | Na₂CO₃ | 0.55 | 1.00 | 4.44 | 2.22 | 0.50 | 3.31 | 0.50 |
| | NaNO₃ | 0.19 | 0.25 | 1.25 | 1.13 | 1.20 | 1.11 | 1.20 |
| | K₂CO₃ | 0.34 | 0.75 | 1.00 | 1.14 | 4.44 | 1.33 | 4.44 |
| | KNO₃ | 0.40 | 0.50 | 0.50 | 0.22 | 1.00 | 0.88 | 1.00 |
| | RbO₂ | 0.74 | 1.00 | 0.44 | 0.11 | 1.00 | 0.33 | 1.00 |
| | Cs₂O | 0.74 | 0.25 | 0.45 | 0.55 | 1.00 | 0.11 | 1.00 |
| | 3MgCO₃ | 2.21 | 0.55 | 8.00 | 4.44 | 5.01 | 8.00 | 12.00 |
| | 4MgCO₃ | 1.00 | 0.50 | 0.53 | 0.50 | 0.50 | 1.00 | 0.50 |
| | CaCO₃ | 1.00 | 1.33 | 2.04 | 0.50 | 1.00 | 1.00 | 1.75 |
| | SrO₂ | 2.00 | 0.88 | 2.44 | 2.22 | 0.40 | 0.50 | 3.50 |
| | BaCO₃ | 8.88 | 2.00 | 1.00 | 2.00 | 0.40 | 0.50 | 1.75 |
| | Ba(NO₃)₂ | 3.11 | 1.22 | 1.00 | 2.00 | 0.30 | 0.50 | 0.50 |
| | ZrO₂ | 1.40 | 1.00 | 0.80 | 1.00 | 5.00 | 4.22 | 1.00 |
| | TiO₂ | 10.17 | 22.22 | 18.82 | 22.77 | 20.44 | 18.34 | 24.99 |
| | Nb₂O₅ | 15.33 | 20.78 | 20.33 | 23.44 | 25.44 | 18.99 | 18.33 |
| | Gd₂O₃ | 1.00 | 2.87 | 0.66 | 0.33 | 0.50 | 1.33 | 0.50 |
| | Yb₂O₃ | 1.00 | 5.88 | 0.66 | 0.66 | 0.50 | 0.30 | 0.50 |
| | Y₂O₃ | 1.00 | 1.25 | 0.55 | 0.33 | 1.00 | 0.30 | 1.00 |
| | WO₃ | 0.12 | 1.33 | 0.64 | 0.33 | 0.30 | 2.00 | 0.50 |
| | ZnO | | | | | | | |
| | La₂O₃ | | | | | | | |
| | Sb₂O₃ | | | | | | | |
| | Total | 100.00 | 100.00 | 100.00 | 100.00 | 100.00 | 100.00 | 100.00 |
| Rn₂O (mass percentage %) | | 3.68 | 5.00 | 10.00 | 6.80 | 9.44 | 7.82 | 9.44 |
| Ln₂O₃ (mass percentage %) | | 3.00 | 10.00 | 1.87 | 1.32 | 2.00 | 1.93 | 2.00 |
| RO (mass percentage %) | | 18.20 | 6.48 | 15.01 | 11.66 | 7.61 | 11.50 | 20.00 |
| TiO₂ + Nb₂O₅ + P₂O₅ + RO | | 60.70 | 59.83 | 67.50 | 67.98 | 68.82 | 68.83 | 73.32 |
| (mass percentage %) | | | | | | | | |
| Optical | Refractive | 1.98868 | 2.16558 | 2.11124 | 1.94444 | 2.28033 | 2.04432 | 2.07643 |
| Glass With | Index (nd) | | | | | | | |
| High | Abbe | 22.34 | 16.33 | 17.23 | 22.67 | 16.32 | 22.11 | 22.06 |
| Refractive | number (vd) | | | | | | | |
| Index | Weight per | 2.90 | 2.92 | 2.96 | 2.91 | 2.94 | 2.98 | 2.93 |
| | volume | | | | | | | |
| | (g/cm³) | | | | | | | |
| Optical | Surface | 933.1 | 733.7 | 886.9 | 968.9 | 345.8 | 689.9 | 444.4 |
| Glass With | compressive | | | | | | | |
| High | stress - CS | | | | | | | |
| Refractive | (Mpa) | | | | | | | |
| Index and | Depth of | 51.5 | 97.6 | 56.7 | 78.8 | 12.7 | 88.6 | 7.7 |
| High | Layers | | | | | | | |
| Strength | DOL(μm) in | | | | | | | |
| | compressive | | | | | | | |
| | stress | | | | | | | |

| | | | | | | | | | | Comparative |
|---|---|---|---|---|---|---|---|---|---|---|
| Eample | | 8 | 9 | 10 | 11 | 12 | 13 | 14 | 15 | example |
| Oxide | SiO₂ | 10.35 | 12.66 | 12.14 | 10.08 | 11.26 | 13.62 | 10.16 | 13.11 | 14.00 |
| (mass | P₂O₅ | 10.66 | 12.22 | 15.24 | 12.44 | 16.66 | 11.11 | 12.22 | 10.33 | |
| percentage %) | B₂O₃ | 4.00 | 2.22 | 1.33 | 2.00 | 12.22 | 1.11 | 0.40 | 1.11 | 24.00 |
| | Al₂O₃ | 5.11 | 10.00 | 4.44 | 2.00 | 1.88 | 2.22 | 1.22 | 1.11 | |
| | Li₂CO₃ | 1.00 | 0.20 | 1.33 | 0.64 | 1.33 | 0.64 | 0.40 | 0.44 | |
| | LiNO₃ | 0.50 | 0.10 | 0.50 | 0.11 | 0.50 | 0.11 | 0.11 | 0.10 | |
| | Na₂CO₃ | 4.00 | 0.50 | 4.44 | 4.44 | 4.44 | 3.31 | 4.44 | 0.50 | |
| | NaNO₃ | 1.11 | 1.20 | 0.50 | 1.11 | 0.50 | 1.11 | 2.22 | 1.20 | |
| | K₂CO₃ | 1.33 | 4.44 | 1.33 | 1.33 | 1.33 | 1.33 | 1.33 | 2.22 | |
| | KNO₃ | 0.50 | 1.00 | 0.44 | 0.88 | 0.44 | 0.88 | 0.50 | 1.00 | |
| | RbO₂ | 0.50 | 1.00 | 0.44 | 0.44 | 0.44 | 0.33 | 0.50 | 1.00 | |
| | Cs₂O | 1.00 | 1.00 | 0.33 | 0.50 | 0.22 | 0.11 | 0.50 | 1.00 | |
| | 3MgCO₃ | 6.00 | 4.00 | 2.44 | 10.00 | 4.00 | 2.00 | 4.44 | 2.66 | |
| | 4MgCO₃ | 2.00 | 0.50 | 1.00 | 1.00 | 1.00 | 1.11 | 1.11 | 0.50 | |
| | CaCO₃ | 1.00 | 2.00 | 2.44 | 1.00 | 4.00 | 2.00 | 1.11 | 0.50 | 6.00 |
| | SrO₂ | 1.00 | 2.00 | 2.33 | 1.11 | 1.00 | 2.00 | 1.00 | 1.88 | |
| | BaCO₃ | 1.00 | 2.00 | 2.24 | 1.11 | 1.00 | 1.00 | 1.00 | 1.88 | 10.00 |
| | Ba(NO₃)₂ | 0.50 | 1.00 | 0.33 | 1.11 | 0.50 | 1.11 | 0.55 | 0.50 | |
| | ZrO₂ | 2.44 | 2.22 | 0.66 | 4.22 | 4.66 | 0.55 | 1.11 | 4.22 | 6.00 |
| | TiO₂ | 11.12 | 18.60 | 18.55 | 18.11 | 12.44 | 10.70 | 25.55 | 25.00 | 23.00 |
| | Nb₂O₅ | 28.88 | 16.66 | 17.22 | 14.66 | 24.66 | 40.00 | 16.11 | 24.98 | 2.00 |
| | Gd₂O₃ | 3.00 | 1.00 | 1.00 | 2.00 | 0.66 | 0.88 | 2.55 | 1.22 | |
| | Yb₂O₃ | 1.00 | 1.00 | 1.00 | 5.00 | 1.00 | 0.66 | 0.22 | 1.22 | |
| | Y₂O₃ | 1.00 | 0.32 | 5.00 | 1.00 | 1.00 | 1.00 | 1.25 | 0.64 | |
| | WO₃ | 1.00 | 2.16 | 3.33 | 3.71 | 2.86 | 1.11 | 10.00 | 1.68 | |
| | ZnO | | | | | | | | | 1.00 |
| | La₂O₃ | | | | | | | | | 13.90 |
| | Sb₂O₃ | | | | | | | | | 0.10 |
| | Total | 100.00 | 100.00 | 100.00 | 100.00 | 100.00 | 100.00 | 100.00 | 100.00 | 100.00 |
| Rn₂O (mass percentage %) | | 9.94 | 9.94 | 9.31 | 9.45 | 9.20 | 7.82 | 10.00 | 7.46 | 0.00 |
| Ln₂O₃ (mass percentage %) | | 5.00 | 2.32 | 7.00 | 8.00 | 2.66 | 2.54 | 4.02 | 3.08 | 0.00 |
| RO (mass percentage %) | | 11.50 | 11.50 | 10.78 | 15.33 | 11.50 | 9.22 | 9.21 | 7.92 | 16.00 |
| TiO₂ + Nb₂O₅ + P₂O₅ + RO | | 62.16 | 58.98 | 61.79 | 60.54 | 65.26 | 71.03 | 63.09 | 68.23 | 41.00 |
| (mass percentage %) | | | | | | | | | | |
| Optical Glass | Refractive Index | 2.36442 | 2.33211 | 2.38964 | 2.14643 | 2.18656 | 2.23645 | 1.99783 | 2.40343 | 1.91 |
| With High | (nd) | | | | | | | | | |
| Refractive | Abbe number (vd) | 15.68 | 15.99 | 15.23 | 17.22 | 16.13 | 16.79 | 22.66 | 15.01 | — |
| Index | Weight per | 2.96 | 2.98 | 2.99 | 2.98 | 2.99 | 2.96 | 2.93 | 2.99 | 4.50 |
| | volume (g/cm³) | | | | | | | | | |
| Optical Glass | Surface | 833.7 | 225.8 | 899.9 | 944.3 | 657.9 | 722.3 | 788.5 | 845.8 | — |
| With High | compressive | | | | | | | | | |
| Refractive | stress - CS (Mpa) | | | | | | | | | |
| Index and | Depth of Layers | 44.6 | 5.6 | 44.4 | 88.6 | 45.1 | 86.3 | 66.8 | 23.6 | — |
| High Strength | DOL(μm) in | | | | | | | | | |
| | compressive | | | | | | | | | |
| | stress | | | | | | | | | |

The refractive index (nd) and the Abbe number (vd) of the optical glasses in the examples and the comparative example were determined according to the V-block method specified in JISB7071-2:2018. Here, the refractive index (nd) was determined for a d line (587.56 nm) of a helium lamp. The Abbe number (vd) was calculated by using the values of the refractive index (nd) of the d line of the helium lamp, a refractive index (n_{F}) of an F line (486.13 nm) of a hydrogen lamp, a refractive index (n_{C}) of a C line (656.27 nm) of the hydrogen lamp, and the numerical formula for Abbe number (vd)=[(nd−1)/(n_{F}−n_{C})]. The refractive index (nd) and the Abbe number (vd) were determined by testing a glass obtained at a slow cooling of a temperature-decreasing speed of −25° C./hr.

The weight per volume (g/cm³) of the optical glasses in the examples was determined based on the method of measuring density and weight per volume by hydrostatic weighing method according to JISZ8807:2012.

The surface compressive stress (CS) and the total thickness of the compressive stress layers (depth of layer DOL) were determined by using a FSM-6000LE series glass surface stress meter manufactured by ORIHARA. A light source with a wavelength of 596 nm was selected as a light source for the measuring machine used in the CS test. The refractive index value at the wavelength of 596 nm was calculated from the refractive index measurement values at the wavelengths of C, d, F and g lines by second-order approximation according to the V-block method specified in JISB7071-2:2018.

It can be concluded from the above table that all the crystallized optical glasses obtained by the examples of the present invention meet the requirements of CS being 225.8-968.9 Mpa and DOL of 5.6-97.6 μm. Accordingly, they can all achieve the technical effects of increasing the surface compressive stress of the compressive stress layers while reducing the central compressive stress, and having strong impact resistance, meaning that even if the glasses are impacted and thus damaged, they are not easy to be broken into shattered fragments.

The above description merely describes the preferred embodiments of the present invention, and is not intended to limit the present invention in any form. The protection scope of the present invention shall be defined by the protection scope of the claims. Although the preferred embodiments of the present invention are disclosed above, the embodiments are not intended to limit the present invention. Any of those skilled in the art may make some changes or modifications according to the above disclosure to obtain embodiments of equivalent technical effects without departing from the scope of the technical solutions of the present invention. Any simple amendment, equivalent variations, and modification made based on the above embodiments according to the technical essence of the present invention without departing from the teachings of the technical solutions of the present invention shall fall within the scope of the technical solutions of the present invention.

What is claimed is:

1. An optical glass, comprising the following oxides in mass percentage relative to a total mass of the optical glass:
0%-30.0% SiO₂, 10.0%-30.0% P₂O₅, 0.1%-5.0% B₂O₃, 0.1%-10.0% Al₂O₃, 0.1%-10.0% Rn oxides, 1.0%-20.0% R oxides, 0.1%-5.0% ZrO₂, 10.0%-30.0% TiO₂, 15.0%-50.0% Nb₂O₅, 0.1%-10.0% Ln oxides, and 0.1%-10.0% WO₃, wherein TiO₂+Nb₂O₅+P₂O₅+the R oxides accounts for 60.01% or above.

2. The optical glass of claim 1, wherein the R oxides comprise 3MgCO₃, 4MgCO₃, CaCO₃, SrO₂, BaCO₃, and Ba(NO₃)₂.

3. The optical glass of claim 1, wherein the Ln oxides comprise Y₂O₃, Gd₂O₃, and Yb₂O₃.

4. The optical glass of claim 1, wherein the optical glass has a refractive index (nd) between 1.80000 and 2.40000, a λ80 of less than 430 nm, and an Abbe number (vd) between 15.0 and 25.0.

5. The optical glass of claim 1, wherein the optical glass has a weight per volume of between 2.90 g/cm³ and 3.00 g/cm³.
